(19) United States
(12) Patent Application Publication
(10) Pub. No.: US 2015/0134415 A1
(43) Pub. Date: May 14, 2015

(54) Automated Process for Obtaining, Analyzing and Displaying Data in Story Form

(71) Applicant: Diffusion Group, LLC dba Melt Media, Tempe, AZ (US)

(72) Inventors: Justin Grossman, Scottsdale, AZ (US); Mike Moulton, Chandler, AZ (US); Christian Trimble, Tempe, AZ (US); Lynn Fisher, Tempe, AZ (US); Ron Barry, Scottsdale, AZ (US)

(73) Assignee: DIFFUSION GROUP, LLC DBA MELT MEDIA, Tempe, AZ (US)

(21) Appl. No.: 14/519,662

(22) Filed: Oct. 21, 2014

Related U.S. Application Data
(60) Provisional application No. 61/903,557, filed on Nov. 13, 2013.

(51) Int. Cl. G06Q 30/02

(52) U.S. Cl. CPC G06Q 30/0203
USPC 705/7.32

(57) ABSTRACT

Computer-implemented method for transforming a user's raw data into suggested actions to improve business function. In the preferred embodiment, the method is applicable particularly to online social media data and the effect the user's marketing has on it. The user selects a desired topic and goals from displayed lists. The system determines story questions having quantifiable answers needed to understand how to meet the goals. The system identifies data types necessary to answer each story question and which data sources have the necessary data types. Using user-provided logon credentials, the system accesses, copies and stores necessary data and uses it to compute answers to story questions. The system identifies actions from a predetermined set of actions that the user could take to meet his goals. The system presents results in a story form using sentences and graphics, which are more easily comprehended than a tables and dashboards.

### CROSS-REFERENCE TO RELATED APPLICATIONS

This application claims the benefit of co-pending U.S. Provisional Application No. 61/903,557 filed Nov. 13, 2013.

### FIELD OF INVENTION

This invention relates generally to transforming a pool of raw data into actionable insights. This invention relates particularly to a computer-implemented method for obtaining and analyzing data then displaying in story form useful metrics and suggested actions to improve a business function.

### BACKGROUND

There are many digital tools that help businesses gather analytics for various business functions, but none of these tools help businesses make decisions. The main cause of this problem is two-fold. Data is in multiple silos, or each tactic is looked at individually, versus a more holistic approach. Social media data presents particular problems because the data is in different formats and difficult to compare and harmonize. The other problem is the sheer amount of data; it's difficult to know which data are relevant to a specific issue. The methodology of how to “make decisions” from this data is not occurring at all or being done in an ad hoc and inefficient manner.

For example, marketing is the process of promoting a product or service to customers, for the purpose of selling that product or service. The marketing process includes analyzing data to identify relevant customers, understand customer buying behavior, and shape marketing strategy and tactics. A wide variety of data types is used, and the data comes from a variety of sources. Qualitative and quantitative data are gathered on paper and electronically. Digital marketing uses electronic devices such as computers, tablets, smartphones, kiosks, and game consoles to communicate aspects of the product or service to customers. The electronic communications and much of the recipients' reactions can be measured, which generates a large amount of data relatively easily compared to non-digital marketing. That volume of data is not necessarily easier to turn into useful information, however. Making this data useful requires transforming sets of numbers into usable insights for marketers.

Consequently companies work directly with human marketing consultants to determine which data to gather, analyze the data, and create plans based on the data as to how best market the product or service. Despite common questions marketers are faced with to make decisions, due to the wide variety in data, types of products and services, and marketing options, each marketing plan has been necessarily customized for each case. Each unique marketing plan was then presented to the customer by the marketing consultant. Customized business processes like marketing do not readily lend themselves to quick or low-cost implementation.

The same is true for other business functions such as finance, human relations. There is a need to automate the process of obtaining, analyzing and displaying data for business functions. It would be desirable to systematize and automate the analysis.

### SUMMARY OF THE INVENTION

This computer-implemented method transforms raw data into actionable insights by identifying data needed to answer certain questions, obtaining that data from one or more data stores, using the selected data to compute the answers to the questions, and using the answers to determine suggested actions. The method is applicable to a wide variety of business functions and in the preferred embodiment the method is applied to marketing. In the preferred embodiment, the method is applicable particularly to the effect of marketing on customers as evidenced by social media, and how to change the effect.

To begin, the system displays a list of topics to a user. The user selects a topic from the list. The system displays a list of goals related to the topic, and the user selects his goals. From the selected topic and goals, the system determines story questions having objective, quantifiable answers, which are needed to understand how to meet the goals.

To get the answers, the system identifies certain types of data necessary to answer each question. The system determines which data sources have the necessary type of data and displays the data sources to the user. The user enters his logon credentials for accessing the data sources and the system validates that the logon credentials will enable it to access the user's data. The system accesses the user's data sources using the user's credentials and uses the selected data to answer the story questions. With the answers, the system identifies actions from a predetermined set of actions that the user could take to make progress toward his goals. The system presents the results in a story form using sentences and graphics, which are more easily comprehended than a table or dashboard presentation of bare numeric and non-numeric results of a conventional data analysis.

The method is conducted online and does not require that humans interact directly with the user. The systematized and automated method enables the user to gain insight into his topic nearly instantaneously and at relatively low cost. Optionally, the system can be configured to automatically re-run the analysis in the future, at predetermined time intervals or upon a defined event to determine whether the actions resulted in improvement towards the goals.

### BRIEF DESCRIPTION OF THE DRAWINGS

FIG. 1 is a schematic illustration of the system.

FIG. 2 is a flow chart illustrating the method from the user's perspective.

FIG. 3 is a flow chart illustrating the method from the system perspective.

FIGS. 4A-H shows a report generated by the system.

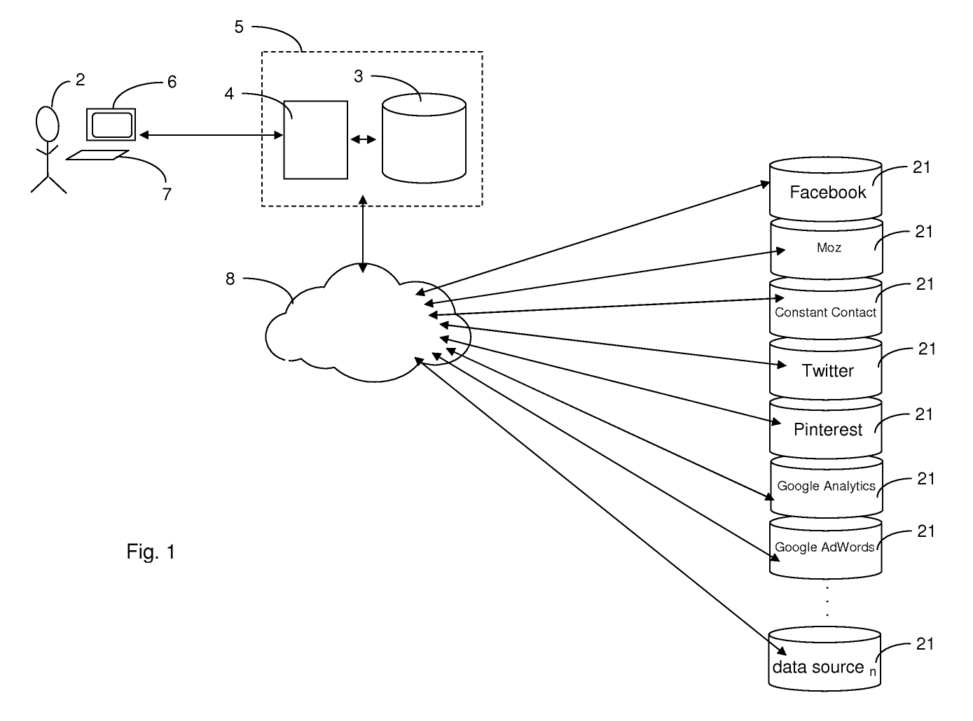

### DETAILED DESCRIPTION OF THE INVENTION

This computer-implemented method transforms a user's raw data relating to a given business function into suggested actions a user can take to improve the business function. The method can be applied to any business function, but typically is applied to business functions that have vast amounts of quantifiable data that defy easy analysis, in part because of the quantity and in part because the conclusions to be drawn from the data are not numbers that can be mechanically calculated, but intuitive conclusions, such as suggested human actions that are likely to improve the business function. The method can be applied to business functions such as marketing, finance, human relations, customer service, and other business operations.

The method is implemented on a system having one or more computing devices 5, each of which has a processor 4 and memory 3, such as those found in a desktop computer, laptop computer, tablet, smartphone or other computing device. Each computing device is in communication with a monitor 6, such as a standalone monitor used with a desktop computer, the screen of a laptop or tablet, or the screen integral with a phone. Each computing device is also in communication with an input device 7, such as a keyboard, touchpad, touchscreen, mouse, or microphone. Each computing device is in communication with a computer network 8, preferably the internet, but possibly also an intranet or extranet, that enables the system to communicate with data sources 21. The communication between components can be wired or wireless.

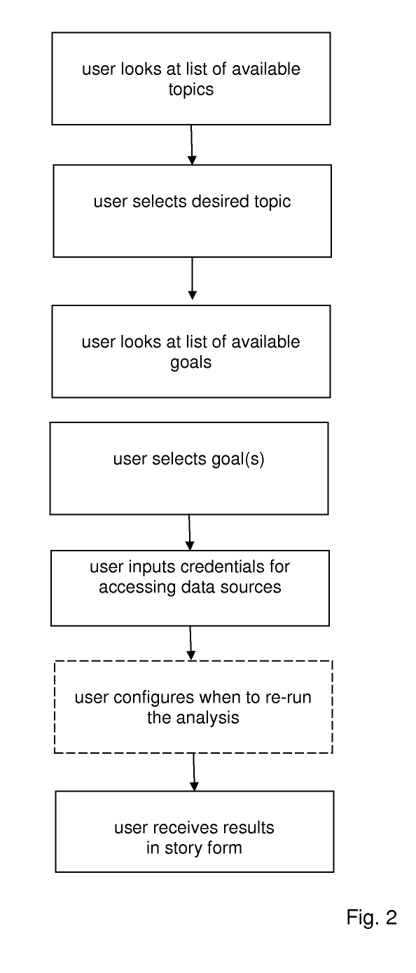

The method is automated except for the actions of the user 2 to input certain information needed to generate results unique to that user 2. Preferably the user input is entered using a wizard, or a step-by-step process that automates the relatively complex task by asking the user a series of easy-to-answer questions. Alternatively, the input can be menu driven. The user may be asked to click on a link or a radio button, or enter data in other ways known in the art. FIG. 2 is a flow chart showing the steps of the method the user takes. As used herein, user means a person, or the entity on whose behalf he is acting, who uses the present method. A customer is a person who interacts with a user's website, makes or receives remarks about the user, or in some way is associated with the user online.

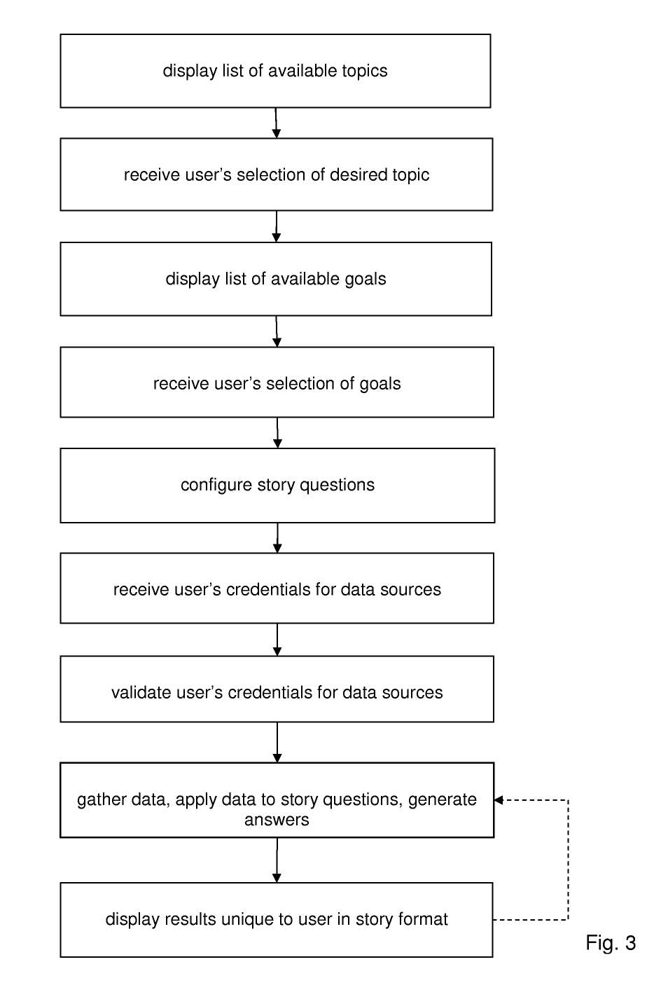

FIG. 3 is a flow chart showing the steps of the method from the system perspective. To begin, the system displays a list of topics 11 to a user 2 from a store of topics stored in memory 3. As used herein, display means to provide the user the information visually or audibly. The topics are stored either locally with the computing device 5 or remotely across the network 8. From the topic choices displayed, the user uses an input device 7 to select a topic about which he wants to understand more. The system then displays a list of goals 12 to a user 2 from a store of goals stored in memory 3 which are associated with the topic. In some cases a certain goal may be associated with more than one topic. From the goal choices displayed, the user uses an input device 7 to select one or more goals which he desires to meet.

Using the selected topic and goals, the system identifies a set of story questions from a store of story questions stored in memory 3 that relate to the selected topic and goal(s). The story questions are predetermined, and guide the user logically from the issue to the conclusions. Typically there are 4-6 questions per story.

To get the answers, the system identifies certain types of data necessary to answer each story question from a store of data types stored in memory 3. The system identifies from a store of data sources stored in memory 3 which data sources have the necessary types of data. The data sources typically have more data types than are necessary to answer the story questions, so the system's identification of the necessary data types serves as a useful filter to limit the amount of data that needs to be culled before answering the story questions. The system then displays to the user the data sources that can provide the necessary data types. For example, for a story related to the effectiveness of social media, the system may display potential data sources such as Facebook® with data relating to reach (e.g. likes and dislikes) and conversions (e.g. customers who took subsequent action); Twitter® relating to reach (e.g. retweet, follow, favorite, mention) and conversions; and Instagram® relating to reach (e.g. likes and dislikes) and conversions.

The data resides on the user's account on the identified data source. To access the data himself, the user would enter certain login credentials such as a username and password. For the system to access the data, the user must provide those necessary login credentials to the system. Thus, the system requests that the user provide to the system his login credentials for each data source. The user enters the information using an input device; the system receives the login credentials and they are stored in memory. The system then tests that the credentials are valid by attempting to log in to the user's account on the data source using the provided credentials. If the system cannot access the data in the data source, it notifies the user that the credentials are invalid. The system may also suggest alternative actions such as requesting that the user re-enter the login credentials, or set up a new account with the data source.

Once the credentials are validated, the system accesses the user's data sources and selects, copies and stores in memory 3 the data necessary to compute answers to the user's story questions. The retrieved data are quantifiable, but not necessarily numeric. For example, numeric data may include the number of visitors each day to a given website and the number of page views, where non-numeric data may include the day that the highest traffic occurs and the type of action most often taken by customers after visiting the page.

The system computes the answers to the story questions using the user's unique data. Additionally, the system may additionally use data that is not unique to the user to help compute the answer, such as trend data or industry data provided by another data source. The analysis is reported by displaying on the monitor a story, in which the topic, goals, story questions, and answers are presented in sentences and graphics, which is more easily comprehended than a table or chart of bare numeric and non-numeric results of a conventional data analysis. The user may distribute the story by forwarding a link to the webpage on which the story is displayed. The user may also save or print out the story.

Optionally, using the answers to the story questions, the system identifies actions from a predetermined set of actions stored in memory 3 that the user should take to meet his goals. The actions are added to the story so that the user not only has a narrative analysis of the data, but specific narrative suggestions for improving the answers to the story questions, which in turn informs actions for meeting the goals. The suggested actions are identified using a series of business rules and algorithms that provide a given recommendation based on the answers generated by the system.

The data used to create a given story changes over time. Optionally, the user can configure the system to run again in the future, at pre-determined time intervals or upon defined events, thereby returning results on different but related data. For example, the report can be quarterly or when the number of unique visitors to the user's website surpasses a specified number or when the number of customers retweeting a tweet surpasses a specified number. To configure the analysis to be re-run, the system displays queries to the user, asking for the time period or event occurrence upon which to re-run the analysis. The user inputs the period or event and the system stores the input in memory. Upon the period or event, the system accesses the user's data sources using the user's previously-provided credentials, and selects, copies and stores in memory 3 the data necessary to re-compute the answers to the story questions previously identified. The new answers to the story questions are displayed on the monitor in a story format, preferably in comparison to the previous answers. In this way the user can determine the effect of any action he took since the last time the story was created. Additionally, using the new answers to the story questions, the system identifies new or additional actions from a predetermined set of actions stored in memory 3 that the user should take to meet his goals. The actions are added to the story. The systematized and automated method enables the user to gain insight into his marketing and recommendations nearly instantaneously and at relatively low cost.

In a preferred embodiment the method is applied to marketing. Marketing data can be measured in a variety of ways, but the metrics themselves do not tell the user how to improve the marketing or even the metrics. This method provides the insight to do so. The system displays to a user a list of topics that relate to marketing which are retrieved from a store of such topics stored in memory. Marketing topics include issues such as how effective the user's website is in attracting desired customers or what people are saying about the user's business. Other common topics include determining how effective the user's social media effort is or how to increase the size of the target audience visiting the user's website.

Marketing topics also include information about sharing content from the user's website; the user's customers contributing content; talking about the user or user's website or products, and consuming the content on the user's website. Sharing describes when a customer informs one or more third parties of the information available from the user's website. Sharing is accomplished when a customer, for example, emails, texts, or tweets a link of the user's webpage to another customer. Contributing describes when the customer adds images, text or sounds to the user's website. Talking describes when the customer makes comments about the user or user's website or products on a website that is not the user's website. Consuming describes when the user views images, reads text, or listens to sound from the user's website.

From the topic choices displayed, the user uses an input device 7 to select a topic about which he wants to understand more: in this case, consuming. The system then displays to a user a list of consuming-related goals which are retrieved from a store of such goals stored in memory. For example, goals associated with consuming include understanding audience growth or how the content is consumed, such as whether the customer watches a video, views a photo or clicks on a link. The user uses an input device 7 to select one or more of these goals. In this example the selected goals are: understanding growth in the number of customers using the user's website and how the content is consumed.

Using the selected topic and goals, the system identifies a set of story questions from a store of story questions stored in memory 3 that relate to the marketing and consuming. At this point the story questions are not displayed to the user. Instead, the story questions are used to determine certain types of data necessary to answer each story question.

In this example, to answer the story questions relating to the relationship of customers consuming the user's data and the growth of the audience, the necessary data types are page likes and follows. These data types are available from data sources Facebook and Twitter. Similarly, to answer the story questions relating to the how the data is consumed, the necessary data types are page likes, post likes, consumptions, and follows. These data types are available from data sources Facebook and Twitter.

The system displays a request that the user enter his logon credentials (such as username and password) for the identified data sources he uses in his business. For example, the user may have credentials to access data from Google® Analytics for the user's website traffic statistics; Google® Adwords for the user's advertisement statistics; Twitter®, Facebook®, Yelp®, and Pinterest® for the user's customer opinion statistics; Constant Contact® for the user's email; and Moz™ for the user's website search statistics; etc.

In this example, the user inputs his logon credentials for Twitter and Facebook. The system validates that the logon credentials enables the system to access the user's accounts. The system then accesses those third-party social media accounts and gathers the data necessary to compute the answers to the story questions.

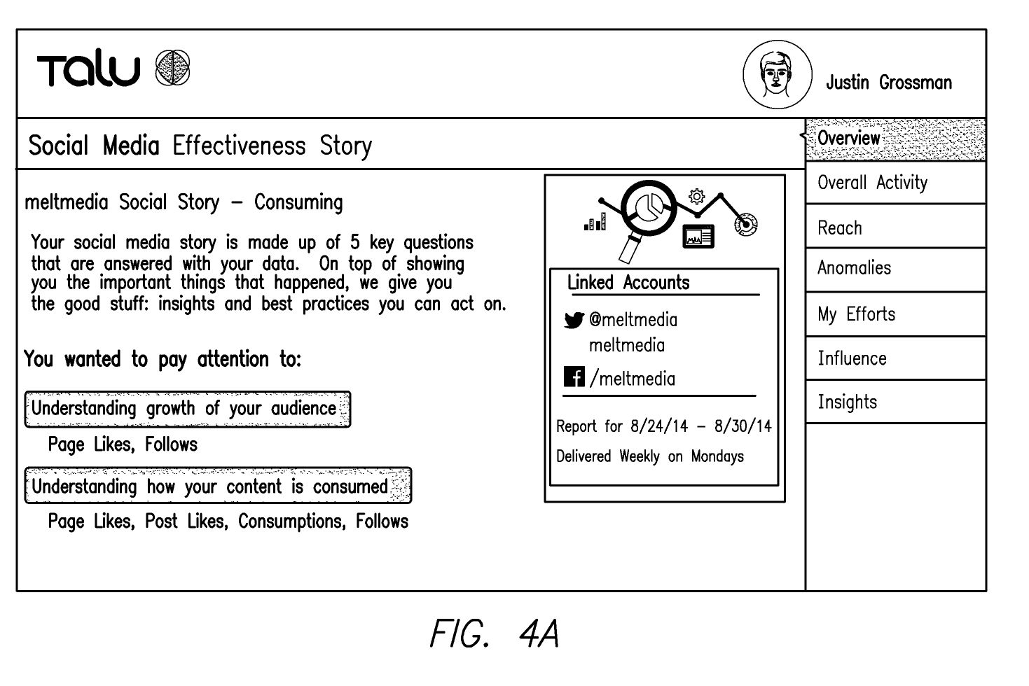

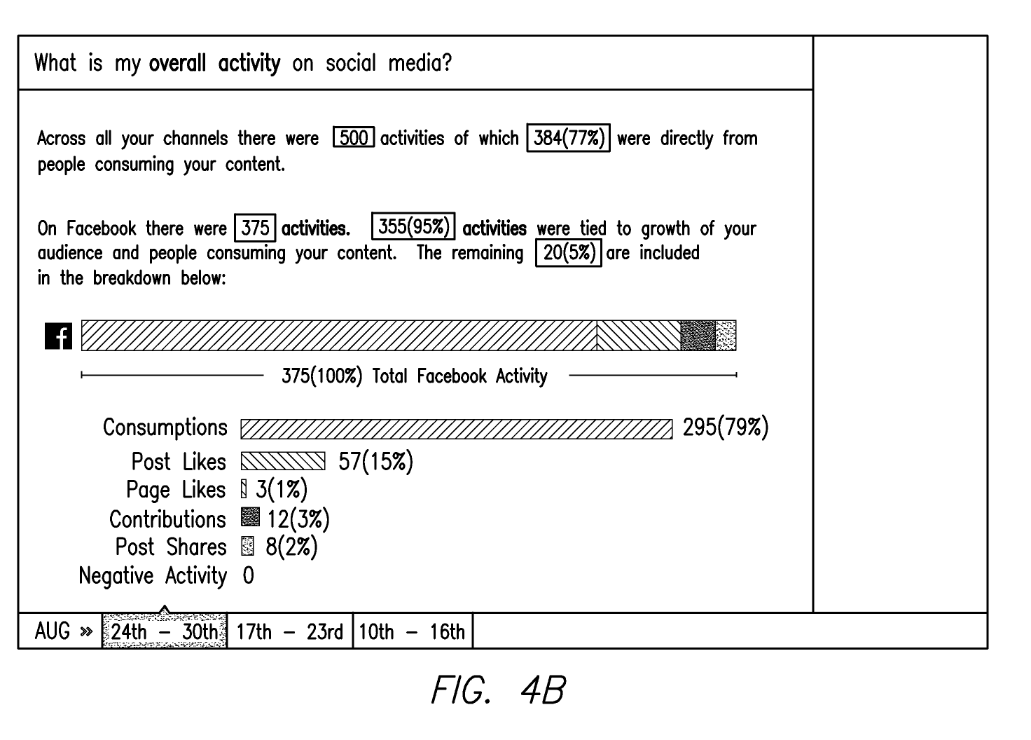

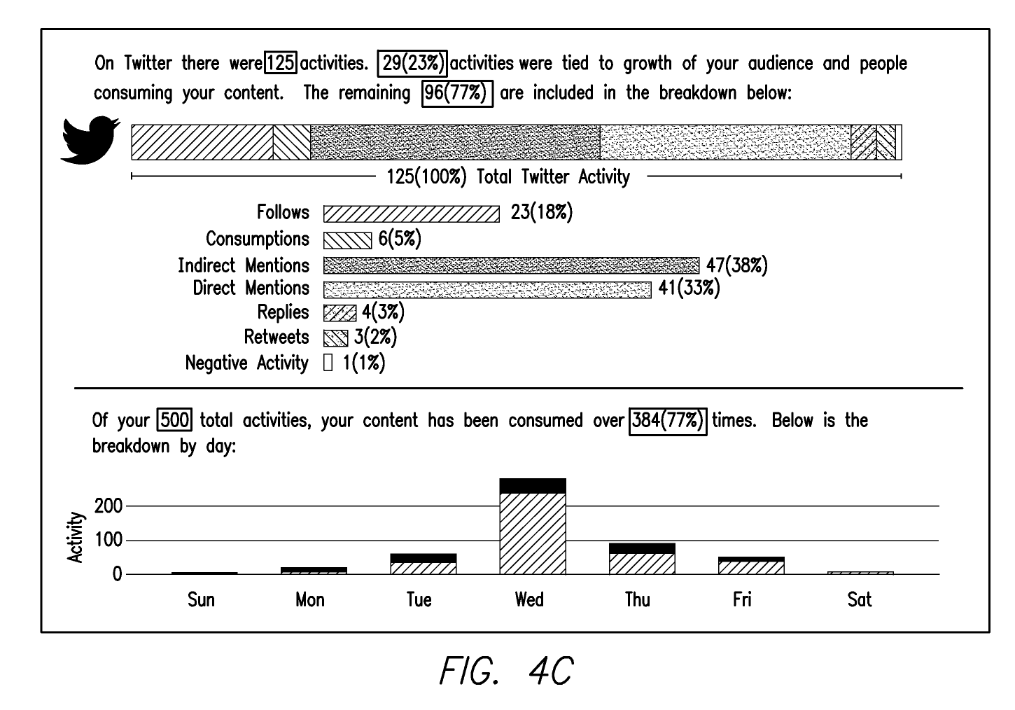

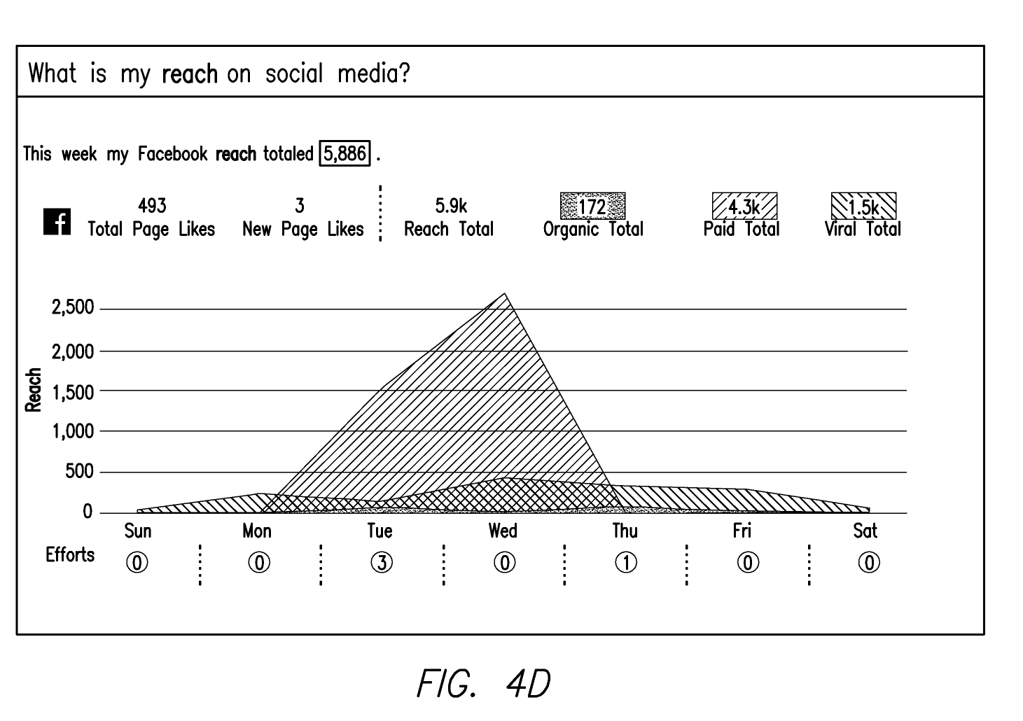

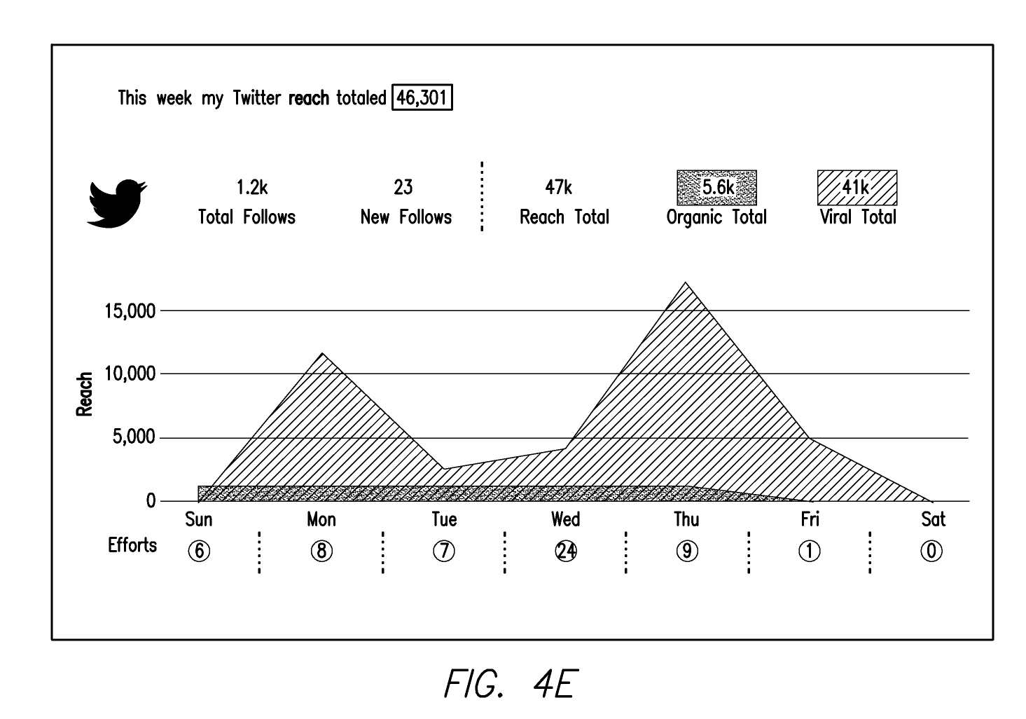

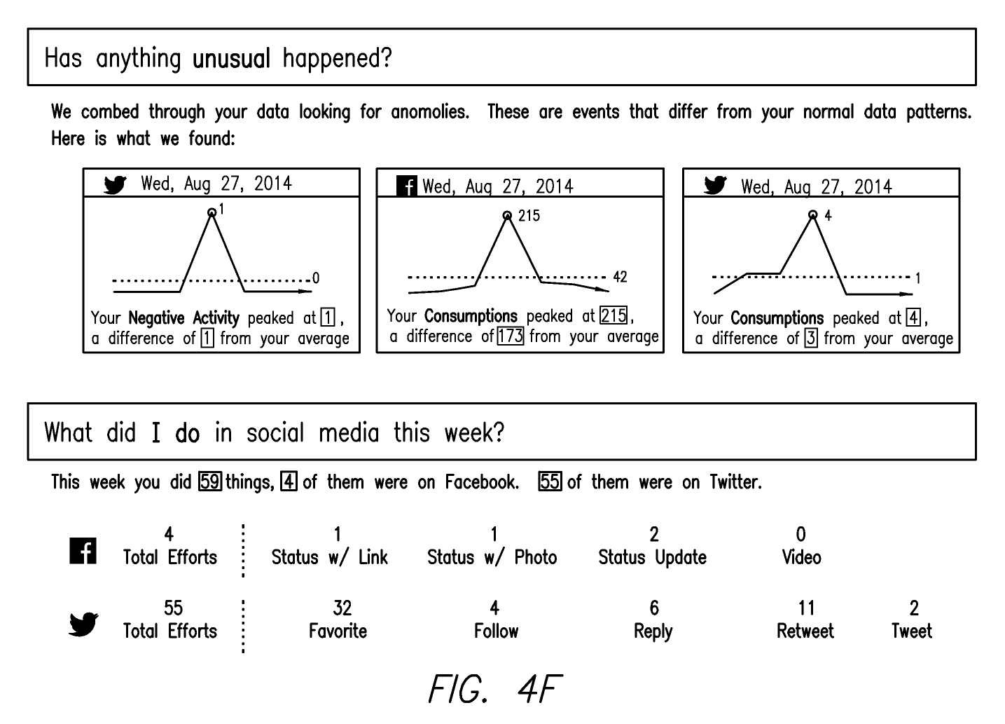

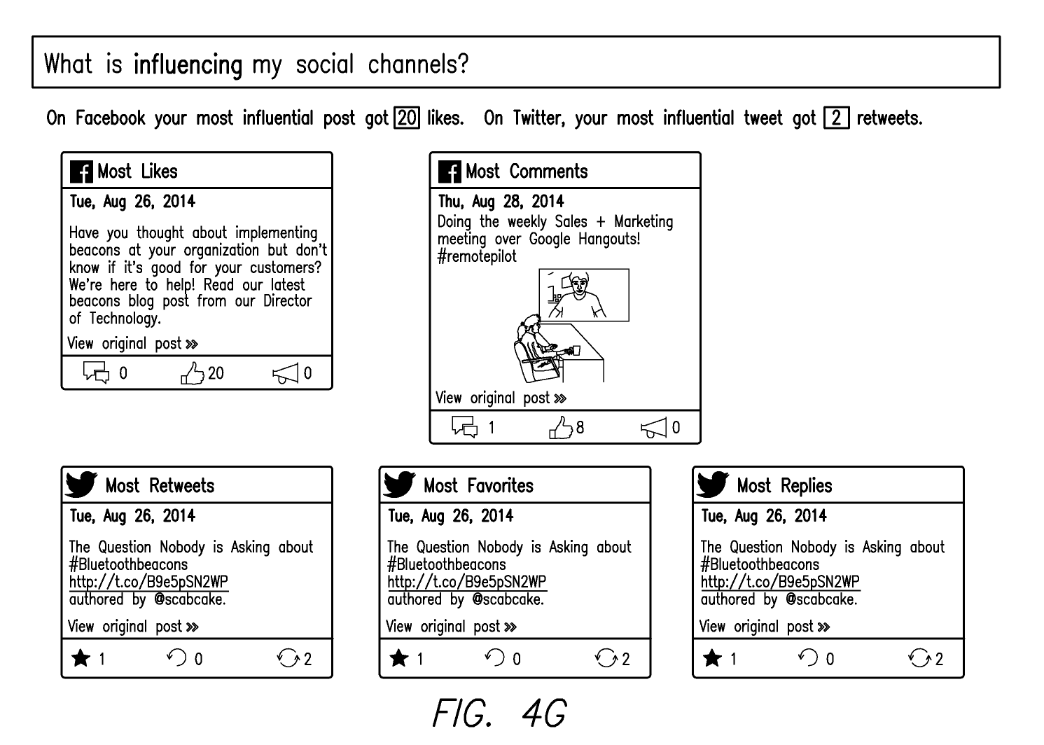

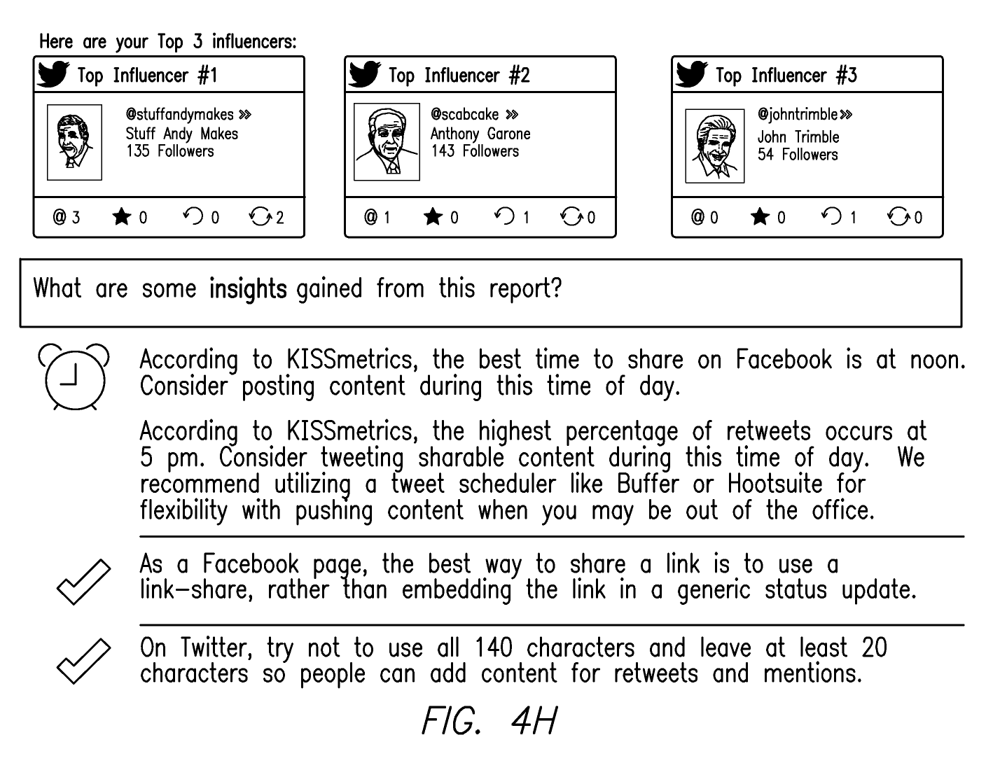

FIGS. 4A-H shows the resultant marketing story. The story is presented on the user's display, so FIGS. 4A-H simulate a story that is conveyed across several screens. In practice, the screenshots shown in FIGS. 4A-H are presented in one continuous image. The story displays the user's selected topic, namely consuming. The story displays the first selected goal, namely understanding growth of the user's audience, and the data types necessary to analyze information related to that goal, namely page likes and follows. The story displays the second selected goal, namely understanding how the user's content is consumed, and the data types necessary to analyze information related to that goal, namely page likes, post likes, consumptions, and follows.

The story also now displays the story questions returned earlier by the system and the answers derived from the accessed data. Both are presented as sentences, as opposed to a table or chart of data. The story questions in this example are:
What is my overall activity on social media?
What is my reach on social media?
Has anything unusual happened?
What did I do in social media this week?
What is influencing my social channels?

The story also displays actions the user can take to improve the growth of his audience and how content is consumed. For example, this story suggests that the user:
Consider posting content at noon
Consider tweeting sharable content at 5 pm
Posting a linkshare in a status update, instead of embedding it
Using 120 characters or less per tweet so others can add content for re-tweets and mentions.

In another exemplary marketing story, the topic is the effectiveness of kiosks as a retail consumer touchpoint to reach the goals of increased impressions (i.e. views of the information on the kiosk) and increased conversions (i.e. customers who input information to inquire about the product or to purchase it). The questions returned by the system are:
What kiosk locations are most effective?
What locations are least effective?
What demographics are most engaged?
How many impressions is the kiosk driving?
How many leads is the kiosk driving?

In another example, for the topic of determining how effective the user's social media effort is, the story questions are:
What is the overall activity from each social media channel?
Which social media channel has the most velocity (over a given time period)?
Is there a channel I need to pay attention to?
Have there been any anomalies?
Which social media activities are the most impactful?
What are my top social media interactions?

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the description.

We claim:

1. A method for collecting, analyzing and customizing the delivery of data to a user an analysis of the user's data, the method comprising:
a. displaying a plurality of topic choices;
b. receiving the user's selection of his desired topic;
c. displaying a plurality of goal choices associated with the selected topic;
d. receiving the user's selection of his one ore more goals;
e. identifying a plurality of story questions associated with the user's selected goals;
f. identifying one or more data types necessary to answer each story question;
g. identifying one or more third-party data sources that provide the identified data types;
h. displaying to the user a list of the identified data sources;
i. requesting from the user credentials for accessing each of the identified data sources
j. receiving the user's credentials for accessing each of the identified data sources;
k. for a first time period:
i. accessing the identified data sources using the user's credentials;
ii. copying and storing a first set of data of the identified data types from the identified data sources;
iii. computing from the first set of data a first answer to each story question; and
iv. displaying the first answer to each of the story questions.

2. The method of claim 1 further comprising:
a. displaying one or more action choices for the user to take to change one or more answers to the story questions; and
b. receiving the user's selection of one or more action choices.

3. The method of claim 2 further comprising:
a. displaying using text and graphics, a story unique to the user, the story comprising:
i. the user's selected topic;
ii. the user's selected goals;
iii. the associated story questions;
iv. the first answers to the story questions; and
v. the action choices.

4. The method of claim 3 wherein at least the selected goals and associated story questions are displayed as sentences.

5. The method of claim 2 further comprising:
a. for a second time period:
i. accessing the identified data sources using the user's credentials;
ii. copying and storing a second set of data of the identified data types from the identified data sources; and
iii. calculating from the second set of data, a second answer to each story question; and
b. comparing the first answers to the second answers; and
c. if the second answer of each story question does not show improvement toward the selected goal over the first answer of each story question, displaying one or more additional action choices for the user to take to change one or more answers to the story questions.

6. The method of claim 1 further comprising:
a. storing the user's credentials in a database;
b. upon receiving the user's credentials, validating the user's credentials for each of the identified data sources; and
c. if the credentials do not validate, notifying the user and requesting additional action.

7. The method of claim 1 wherein at least some of the data is social media data.

8. The method of claim 1 wherein the topic choices relate to marketing.

9. The method of claim 8 wherein the user operates a website for its customers' use and the topic choices comprise:
a. customers sharing content from the user's website;
b. customers contributing to the user's website;
c. customers talking about the user in one or more third-party electronic mediums; and
d. customers consuming content from the user's website.

10. A method for transforming a user's data into a customized output, the method implemented on a computing device having a processor and memory, wherein the computing device is in communication with a monitor, an input device, and a computer network, the method comprising:
a. accessing from the memory a plurality of topic choices stored therein and displaying the topic choices on the monitor;
b. receiving from the input device the user's selection of his desired topic and storing the selection in the memory;
c. accessing from the memory a plurality of available goal choices stored therein and displaying on the monitor one or more goal choices associated with the selected topic choice;
d. receiving from the input device the user's selection of his one or more goals and storing the selection in the memory;
e. accessing from the memory a plurality of story questions stored therein and identifying the story questions associated with the user's selected goals;
f. identifying, from a plurality of data types stored in the memory, one or more data types needed to answer each story question;
g. accessing from the memory a plurality of third-party social media data sources that are available over the computer network, and identifying one or more of the third-party social media data sources that provide the identified data types;
h. displaying on the monitor the identified social media data sources;
i. receiving from the input device the user's credentials for accessing each of the identified social media data sources and storing the credentials in the memory;
j. for a first time period:
i. accessing over the computer network the identified social media data sources using the user's credentials;
ii. copying and storing in the memory a first set of data from the identified data types from the accessed data sources;
iii. using the computer processor, determining a first answer to each story question from the first set of data; and
k. displaying on the monitor using text and graphics, a story unique to the user, the story comprising:
i. the user's selected topic;
ii. the user's selected goals;
iii. the associated story questions; and
iv. the first answers to the story questions.

11. The method of claim 10 wherein at least the selected goals and associated story questions are displayed as sentences.

12. The method of claim 10 further comprising:
a. accessing a plurality of available action choices stored in the memory and displaying one or more of the action choices for the user to take in order to change the answer to one or more of the story questions.

13. The method of claim 10 further comprising:
a. for a second time period:
i. accessing over the computer network the identified social media data sources using the user's credentials;
ii. copying and storing in the memory a second set of data from the identified data types from the identified data sources; and
iii. using the computer processor, determining a second answer to each story question from the second set of data; and;
b. comparing using the computer processor the first answers to the second answers;
c. displaying on the monitor the second answers to the story questions; and
d. if the second answer of each story question does not show improvement toward the selected goal over the first answer of each story question, displaying on the monitor one or more additional action choices for the user to take to change one or more answers to the story questions.

14. The method of claim 10 further comprising:
a. storing the user's credentials in the memory;
b. upon receiving the user's credentials, validating using the computer processor and the computer network the user's credentials for each of the identified data sources; and
c. if the credentials do not validate, notifying the user and requesting additional action.

15. The method of claim 10 wherein the topic choices relate to marketing.

16. The method of claim 15 wherein the user operates a website for its customers and the topic choices comprise:
a. customers sharing content from the user's website;
b. customers contributing to the user's website;
c. customers talking about the user in one or more third-party electronic mediums; and
d. customers consuming content from the user's website.

17. A method for collecting, analyzing, and transforming raw data into customized output using a computing system having at least a processor, memory, one or more input devices, one or more output devices, and communications components for communicating with remote servers and databases accessed through a computer network, the method comprising:
a. accessing a database stored locally on or remotely from the computing system, the database containing topic choices relating to a user's area of business and providing a user with a plurality of topic choices;
b. receiving and recording the user's selection of his desired topic choice;
c. accessing a database stored locally on or remotely from the computing system, the database containing goal choices associated with topic choices, identifying one or more goal choices associated with the selected topic choice, and with an output device of the computing system, providing the user with the goal choices;
d. receiving and recording the user's selection of one or more goals;
e. accessing a database stored locally on or remotely from the computing system, the database containing story questions associated with goal choices, identifying a plurality of story questions relating to the user's selected goals, determining one or more first data types to be collected and analyzed such that an answer each story question can be developed, and identifying one or more third-party social media data sources either locally or remotely over the computer network that provide access to the first data types;
f. if any third-party social media data sources are protected social media data sources such that they require the customer's security information for access, providing to the user a summary of such protected social media data sources and requesting from the user applicable credentials for accessing each of the protected social media data sources;
g. receiving the user's credentials for accessing each of the protected social media data sources;
h. for a first time period:
i. accessing the identified third-party social media data sources through communication with the social media data sources over the computer network and using the user's credentials where necessary;
ii. collecting and storing locally or remotely a first set of data from the first data types accessed through the identified third-party social media data sources;
iii. analyzing the first set of data and developing a first answer to each story question; and
i. providing to the user using text and graphical output, a story unique to the user, the story comprising:
i. the user's selected topic;
ii. the user's selected goals;
iii. the associated story questions; and
iv. the first answers to the story questions;
j. wherein the user is provided, using text and graphical output, topic choices, goal choices, social media information, first answers, and other information using the output devices of the computing system and wherein the user supplies input such as selections of topic choices, goal choices, social media credentials, and other information using the input devices of the computing system.

18. The method of claim 17 wherein at least the selected goals and associated story questions are displayed as sentences.

19. The method of claim 17 further comprising:
a. accessing a plurality of action choices stored locally or remotely, identifying the action choices that, given the user's previous selections, will change one or more of the analysis of the data, the set of data analyzed, and the resulting answers to one or more story questions, and providing the identified action choices to the user; and
b. receiving the user's selection of one or more of the action choices and storing the user's selection in the memory of the computing device;
c. wherein the user further supplies input such as action choices using the input devices of the computing system.

20. The method of claim 19 further comprising:
a. for a second time period:
i. accessing the identified third-party social media data sources through communication with the social media data sources over the computer network and using the user's credentials where necessary;
ii. collecting and storing locally or remotely a second set of data from the first data types accessed through the identified third-party social media data sources;
iii. analyzing the second set of data and developing a second answer to each story question; and
b. providing to the user the second answer to each of the story questions;
c. comparing the first answers from the first time period to the second answers from the second time period; and
d. accessing a plurality of additional action choices stored locally or remotely, identifying the action choices that, given the user's previous selections, will change one or more of the analysis of the data, the set of data analyzed, and the resulting answers to one or more story questions, and providing the identified action choices to the user;
e. wherein the user is further provided second answers and additional action choices using the output devices of the computing system.

21. A method for collecting, analyzing, and transforming a user's raw social media data into customized output using a computing system having at least a processor, memory, one or more input devices, one or more output devices, and communications components for communicating with remote servers and databases accessed through a computer network, the method comprising:
a. receiving the user's selection of a topic and one or more goals relating to marketing;
b. identifying, from a store of story questions stored in the memory, a plurality of story questions associated with the user's selected goals;
c. identifying from a store of data types stored in the memory one or more data types necessary to answer each story question;
d. identifying from a store of third-party social media data sources stored in the memory one or more data sources that provide the identified data types;
e. receiving the user's credentials for accessing each of the identified data sources;
f. accessing the identified data sources using the user's credentials;
g. computing from data retrieved from the data sources a first answer to each story question; and
h. displaying the first answer to each of the story questions in a sentence.
